(19) United States
(12) Patent Application Publication
(10) Pub. No.: US 2006/0229764 A1
(43) Pub. Date: Oct. 12, 2006

(54) Filling amount monitoring method and devices

(75) Inventors: Manfred Stefener, Munchen (DE); Jens Muller, Munchen (DE); Oliver Freitag, Munchen (DE); Kurt Rothkoof, Munchen (DE)

Correspondence Address: IP STRATEGIES, 12 1/2 WALL STREET, SUITE I, ASHEVILLE, NC, 28801, US

(73) Assignee: SFC SMART FUEL CELL AG, Brunnthal-Nord (DE)

(21) Appl. No.: 10/524,639

(22) PCT Filed: Jul. 30, 2003
(86) PCT No.: PCT/EP03/08429

§ 371 Date: Apr. 20, 2006

(30) Foreign Application Priority Data
Aug. 13, 2002 (EP) 02018113.7

(51) Int. Cl. G06F 17/00

(52) U.S. Cl. 700/239

(57) ABSTRACT

The present invention relates to a method for monitoring the amount of fluid in a fluid container, wherein the amount of fluid contained in the fluid container is determined at a first moment in time, said step comprising reading out information provided on the fluid container, and wherein, at a second moment in time, the amount of fluid is determined that has been removed between said first and second moments in time, and wherein at least one quantity is stored, which is representative of the amount of fluid contained in the fluid container at said second moment in time. Furthermore, the invention relates to a fluid container comprising an information storage means which is adapted to have stored therein the amount of fluid contained in the fluid container or at least one other quantity that is representative of the amount of fluid contained in the fluid container. The invention additionally relates to a system for using such fluid containers.

The present invention relates to a method for monitoring the amount of fluid in a fluid container, wherein the amount of fluid contained in the fluid container is determined at a first moment in time, and wherein, at a second moment in time, the amount of fluid is determined that has been removed between said first and second moments in time, and wherein at least one quantity is stored, which is representative of the amount of fluid contained in the fluid container at said second moment in time. Furthermore, the invention relates to a fluid container comprising an information storage means which is adapted to have stored therein the amount of fluid contained in the fluid container or at least one other quantity that is representative of the amount of fluid contained in the fluid container, and/or an encoded means with the aid of which the fluid containers can be distinguished from one another. The invention additionally relates to a system for using such fluid containers.

### PRIOR ART

In many fields of use, devices remove a liquid or gas from liquid or gas containers for supplying said liquid or gas to a system. Examples for such systems are inkjet printers, internal combustion engines, gas cookers, fuel cells, etc.

A user of such systems normally wants information so as to know how long he will still be able to operate the system with a container connected thereto or how many pages he will still be able to print, or which distance he will still be able to travel, etc.

It is therefore often necessary or at least desirable to provide these systems with a unit which keeps the user informed of the current contents of the container and/or which provides information (e.g. residual operating time) depending on the current contents of the container.

In the case of gas containers, the conventional methods for indicating the contents of the container are normally based on pressure measurements. The pressure measured can simply be converted into a filling amount, since—in an approximation that is precise enough for most cases of use—the gas pressure is proportional to the gas quantity.

In the case of liquids, filling level measurements are normally carried out. For this purpose, it is either possible to use the position of the liquid level directly relative to the optical filling level indication (e.g. coffee machine), or it is possible to use floaters for determining the liquid level and, from said liquid level, the filling level (e.g. motor vehicles). The values provided by these methods are normally only reliable when the container occupies a specific position. In the case of non-transparent containers or containers that are installed in devices, a filling level indication which is visible at any time will, moreover, entail a substantial outlay (e.g. fuel indicator in motor vehicles).

For large-volume stationary liquid containers also acoustic methods (ultrasound) are used for determining the amount of liquid contained in the container. For smaller containers this method is, however, less suitable or even unsuitable. Especially for small-volume mass articles, e.g. ink cartridges, fuel cartridges (gas or liquid), etc., most of the above-mentioned methods cannot be used for reasons of costs and/or space and/or complex container geometries and/or variable container orientations.

### DESCRIPTION OF THE INVENTION

In view of the above-described situation, it is the object of the present invention to provide a method which allows to determine the content (or the residual content) in fluid containers while avoiding the various above-mentioned disadvantages.

Furthermore, it is the object of the present invention to provide fluid containers and fluid withdrawal systems which are configured such that the content of the fluid containers can be determined making use of the method according to the present invention.

According to the present invention, a method for monitoring the amount of fluid in a fluid container is provided, said method comprising the following steps: determining, at a first moment in time, the amount of fluid contained in the fluid container, said step comprising reading out information provided on the fluid container; determining, at a second moment in time, the amount of fluid that has been removed from the fluid container between said first and second moments in time, and storing at least one quantity which is representative of the amount of fluid contained in the fluid container at said second moment in time.

The advantage of the present invention is based on the fact that, in the case of the method for monitoring the amount of fluid in a container according to the present invention, it is not necessary to measure the amount of fluid in the container, but the amount of fluid taken out during fluid withdrawal is ascertained directly (e.g. by means of a flowmeter) or indirectly (e.g. via the number of operations, etc.) and the value relevant at the second moment in time is ascertained by subtracting this amount of fluid from an initial value at the start (first moment in time) of the fluid withdrawal.

When the present method is used, two situations have to be distinguished in some cases of use, viz. whether or not fluid had already been removed prior to said “first moment in time”. If this was not the case, the determination of the amount of fluid can take place in a simple manner at the first moment in time by establishing that a filled fluid container contains a predetermined amount of fluid. For example, standardized gas cartridges, which are primarily used for camping/caravan purposes, are pierced by a withdrawal means for removing fluid therefrom so that they can only be installed in the withdrawal device in a completely filled condition.

However, for determining the amount of fluid contained in the fluid container, it does, in many cases, not suffice to merely establish that fluid has not yet been removed from the fluid container used. In particular, one and the same type of fluid containers with different filling amounts may e.g. be provided.

“Provided information” means that this information can only be read out, but cannot be overwritten within the framework of said method. An example for the provision of said information is a glued-on barcode. In addition to the indication of the original filling amount, said information may also comprise data which serve to identify the fluid container and on the basis of which said fluid container can be distinguished from other fluid containers.

According to a preferred embodiment, the determination of the amount of fluid contained in the fluid container at said first moment in time comprises reading information from an information storage means. This information storage means can be provided on the fluid container as well as in the withdrawal system. It has stored therein at respective predetermined moments in time or at moments in time determined in some other way the at least one quantity which is representative of the amount of fluid contained in the fluid container at these moments in time. When a withdrawal process is started, but possibly also at other moments in time, this information storage means is read so as to determine from said at least one quantity the amount of fluid contained in the fluid container at this moment in time. This quantity may be directly proportional to the amount of fluid, but it may also comprises a rounded and perhaps coarse-step percent information on the still existing amount of fluid.

The readout of information from the information storage means and also the storing of information in the information storage means is effected by a read/write unit which is connected to a control unit. The control unit monitors or determines the amount of fluid removed between the first and the second moment in time. This can be done directly by measuring the flow rate, but also indirectly by power measurements, sheet counters (in printers), etc.

How often and at which moments in time writing and reading is executed depends on the particular case. When fluid is removed in the form of a continuous flow of fluid, it will be expedient to define each start of a withdrawal process as a first moment in time and each end of a withdrawal process as a second moment in time. In this case, the information storage means will only be written to at the end of a fluid withdrawal process and information will be read therefrom at the start of a withdrawal process. Alternatively, a predetermined time interval can be given, the respective stored quantity(ies) being updated when said predetermined time interval has elapsed. Likewise, an amount of fluid may be predetermined, the respective stored quantity(ies) being updated when said amount of fluid has been removed.

The information storage means may selectively be provided on the fluid container or in the withdrawal system. However, even if the fluid container itself is provided with an information storage means, it will be advantageous—e.g. for keeping the number of read/write processes on the fluid container small—when the control unit is able to access an information storage means (e.g. a RAM) which is independent of the fluid container. In this independent information storage means continuously updated values can be stored temporarily so that the information storage means will only have to be written to at the end of a withdrawal process; perhaps such writing can even be postponed until the (still partly filled) fluid container is intended to be removed. If it is possible without a substantial technical outlay, the continuously updated values may, however, also be stored in the information storage means of the fluid container.

According to a particularly user-friendly further development, the method according to the present invention comprises the indication of the at least one quantity which is representative of the amount of fluid in the fluid container. The quantity indicated can comprise the residual amount of fluid in the fluid container and/or the residual operating time of a device operated with said fluid and/or the number of operations which can still be carried out with the residual amount of fluid. The representative value may also be complementary to the amount of fluid in the fluid container, i.e. it may comprise e.g. the amount of fluid removed from the fluid container and/or the operating time achieved by the connected fluid container and/or the number of operations that have been carried out up to the moment in question. Which of these quantities is the most informative one depends on the respective field of use. In the case of a printer provided with printing cartridges which, starting from a mean consumption value, have a capacity that suffices to print 1000 pages (only by way of example), an indication of the number of pages that has been printed up to the moment in question may be more expedient than an inevitably inaccurate indication of the number of pages that can still be printed. In the case of an emergency power unit operated with a fuel container, the residual operating time which can be achieved by the amount of fuel contained in the fuel container at the moment in question is, however, of paramount importance. It is also possible to indicate a plurality of quantities at the same time, e.g. the residual operating time in the case of “idling speed” (“idling”) and in the case of “full throttle” (maximum power), the number of pages that can still be printed when printing is effected with minor and maximum quality, etc. All these quantities that can be indicated can be stored in the information storage means of the fluid container.

According to a specially preferred embodiment of the method according to the present invention, safety measures will be taken when the at least one representative quantity falls below or exceeds at least one predetermined value. The withdrawal of fluid from the fluid container in question can, for example, be discontinued, when the filling amount falls below a predetermined value, so as to avoid e.g. the withdrawal of a gas phase, instead of a liquid, from said fluid container. In the case of printers it is thus possible to discontinue e.g. a print job, if it has to be reckoned with that the subsequent printouts, or at least part of said printouts, would no longer be executed with satisfactory quality. If desired, an option can be provided, which allows to suppress the initiation of such safety measures in general or, in a particular case, after each occurrence.

Safety measures, such as the discontinuance (of the attempt) to remove fluid can, alternatively or additionally, also be initiated when the at least one representative quantity falls below or exceeds at least one predetermined value and/or when the information provided on the fluid container cannot be read and/or when information is not provided on the fluid container and/or when the information storage means cannot be read from and/or written to.

This can protect against risks that may occur in cases where the fluid container is damaged or not adequately connected or not used correctly. Refilling of the fluid container may be precarious for reasons of safety because handling of the fluid as such may be dangerous or because the container may not be suitable to be reused. If such filling of a previously emptied container is carried out nevertheless, the information storage means will still indicate the information that the at least one representative quantity of this container has fallen below or exceeded at least one predetermined value. Hence, safety measures will be initiated, which cannot even be prevented if the information storage means is provided on the fluid container and if it has been willfully damaged or removed.

In addition to or alternatively to the above-mentioned blocking of fluid withdrawal, the safety measures may also comprise the sending of an acoustic and/or optical signal or signals which, in good time, draw the user's attention to problems or to the imminent necessity of exchanging the fluid container.

In accordance with a specially preferred further development for cases in which the information storage means is provided on the fluid container, the readout and/or storage of information causes irreversible changes in the information storage means. This allows very simple and reasonably-priced embodiments of the information storage means. Information stored at an earlier time can, for example, be replaced by current information in that he former is supplemented, but not, as is customary practice, completely overwritten. In this case, the residual amounts to be stored successively can, for example, be stored only in strictly monotonically decreasing successive values. This will additionally prevent a manipulation of the information stored in the information storage means so that a refilling of already emptied containers by persons who are not qualified or authorized to do so can be prevented even more reliably.

According to a further aspect of the present invention, a fluid container is provided, which comprises an information storage means. The information storage means serves to store at least one quantity which is representative of the amount of fluid contained in the fluid container. The reading of this quantity thus replaces an actual measurement of the amount of fluid contained.

According to a preferred embodiment, an encoded means is additionally provided. The encoded means serves to discriminate fluid containers. It can also serve to indicate at least one quantity which is representative of the amount of fluid that was originally present in the delivered state. The information storage means can comprise the encoded means, e.g. in the form of a section in the information storage means that cannot be overwritten.

The information storage means and/or the encoded means may e.g. be simply applied to a predetermined point of the surface of the fluid container. All the technically more complicated components, which are necessary for ascertaining, reading and writing information, are not constituent parts of the fluid container but of the system using such containers. In this way, a fluid container having a filling amount “indicator” is provided, which does not need a measurement unit (floater, etc.) for determining the filling amount (or a quantity related thereto) and which can therefore have a much simpler structural design and can be produced at a more reasonable price.

According to a specially preferred embodiment, the information storage means of the fluid container is implemented such that the storage of information in the information storage means causes irreversible changes in the information storage means. The resultant advantages have already been mentioned hereinbefore and need not be repeated once more.

In accordance with a particularly reasonably-priced further development, the information storage means may comprise an arrangement of conductor tracks, the information being stored in the arrangement of intact or defective conductor tracks. The fluid container may, for example, have attached thereto a printed circuit board with a plurality of contacts, which are connected by thin conductor tracks. Each of these conductor tracks corresponds to a filling amount. For reading, i.e. for determining the intact conductor tracks, the contacts are brought into contact with respective mating contacts and the resistance values of the conductor tracks are determined. For overwriting the stored filling amount, the conductor track connecting the respective pair of contacts is melted through by applying a voltage to said pair of contacts.

In accordance with an alternative or additional preferred further development, the information storage means of the fluid container comprises an electric and/or magnetic data memory, in particular an EEPROM chip and/or a magnetic foil (e.g. a magnetic tape).

According to another aspect of the present invention, a fluid withdrawal system is provided, which is adapted to be used with the fluid containers according to the present invention and which comprises a fluid withdrawal means that is adapted to have such a fluid container connected thereto, a control unit, and a read/write unit for reading information from the information storage means of the fluid container.

According to a preferred embodiment, the read/write unit can also be adapted to be used for writing information into the information storage means of the fluid container.

In addition to the fluid containers, also the fluid withdrawal system itself can be provided with an information storage means.

In contrast to conventional filling amount measurements in the case of a fluid container, the system according to the present invention is so conceived that the change of the filling amount is observed externally (outside of the fluid container). The necessary outlay is substantially imposed on the system using the fluid containers so that, as a cost factor for the potential mass product fluid container, said outlay will only play a minor role. The additional expenses entailed by a system having the above-mentioned structural design, can be compensated for when the system has been in operation for some time; subsequently, the operating costs of the system according to the present invention will be markedly lower than those of a conventional system which uses fluid containers with filling level measurement.

Additional aspects and advantages of the present invention will be described in the following on the basis of specially preferred embodiments and with reference to a specially preferred field of use.

These specially preferred embodiments and this specially preferred field of use are, however, only referred to for explaining the invention more clearly, but definitely not for limiting the scope of protection disclosed in the claims to these embodiments and/or fields of use.

A specially preferred field of use are mains-independent electric systems which are supplied with voltage/current via fuel cells. These fuel cells can, in turn, be supplied with fuel via exchangeable fuel cartridges. Although the mains-independent power supply is, at present, still dominated by accumulators, fuel cells have numerous advantages in comparison with accumulators in this field. Moreover, they have a promising development potential for the near future.

In order to guarantee interruption-free operation with mobile fuel cells, the user's attention must early enough be drawn to the fact that it will be necessary to exchange the cartridge in the foreseeable future. On the other hand, the total manufacturing costs for an exchangeable fuel cartridge must be markedly lower than 1 euro and dollar, respectively, so as to compete seriously with the accumulator on the mass production market.

Taking additionally into account the costs for the container housing, the connecting mechanism, safety means and the filling, the scope remaining for filling level recognition is at most a few cents. It is therefore impossible to provide complex sensor means in/on the container housing. In addition, due to the desired mobile use, a position-independent determination of the amount of fuel is necessary so that methods in the case of which the position of the liquid level is determined (e.g. floater solutions; resistive or capacitive measurements) cannot be used either.

A specially preferred embodiment of the present invention concerns therefore a special structural design of an exchangeable fuel cartridge and of a system, which allow to store the residual operating time and/or the residual amount and/or other quantities “on” the cartridge and to indicate them when the system is in operation. According to the present invention, the filling level of the fuel cartridge is calculated—on the basis of the information that each new cartridge is completely filled upon delivery and on the basis of the current consumption of fuel during operation, which is a value that is easy to obtain. The respective current filling level is then stored in the memory on the fuel cartridge and regularly reread. Hence, this technique will also work when cartridges are exchanged during operation.

A few advantageous, i.e. extremely reasonably-prices solutions will now be described.

The fuel cartridge has attached thereto a simple, very reasonably-priced memory for the information concerning the filling level and the residual operating time, respectively; this memory is regularly or continuously read and overwritten during operation. Normally, it will suffice to indicate the filling level in a small number of increments, e.g. a five-step scale 0-25-50-75-100% for the filling amount or 8 h-6 h-4 h-2 h-0 h for the residual operating time. More precise indications are, of course, possible as well.

According to an advantageous embodiment, the fuel cartridge has attached thereto a minute printed circuit board with a plurality of e.g. 5 contacts which are interconnected by a very thin copper conductor when the cartridge is new. Making use of n contacts, it is possible to store n different filling levels. The fuel cell system is implemented such that, upon insertion of the cartridge, the contacts come into contact with respective “sensors”. In addition, the system observes the volumetric flow of the fuel that is removed from the cartridge (e.g. by integrating the fluid flow to the dosing pump). When the next filling level has been reached, the thin conductor track is melted through (analogy: electric safety fuse) by applying a voltage to the respective pair of contacts. A short time before the cartridge will be emptied completely, the last pair of contacts is interrupted. This will—optionally—also prevent operation with fuel cartridges that have been refilled against the rules: the system will not work when it has connected thereto a cartridge without conductive end to end contacting. This will simultaneously provide protection against refilling: a non-qualified person will be prevented from refilling the cartridge, since a cartridge refilled in this way will be recognized by the system as “empty” and therefore not accepted. The conductor tracks may, in addition, be provided such that they are concealed, whereby tampering will be excluded even more reliably.

An alternative to the above-described information storage means is a simple EEPROM chip, which is attached to the fuel cartridge as an information storage means. During operation, this memory is read and written anew at regular intervals. Also in this case electronic protection against refilling is optionally provided.

Another alternative is a magnetic foil or a magnetic tape: a small piece of a magnetic data carrier is provided on the fuel cartridge. The write/read unit is positioned in the cartridge shaft of the system. Insertion or removal of the cartridge results “automatically” in the guided movement of the cartridge in the cartridge shaft which has the effect that the magnetic memory is moved past the write/read head. In the course of this movement, the information is read or written.

All the above-described embodiments provide at an extremely reasonable price the possibility of determining the filling amount and the residual operating time of exchangeable fuel cartridges.

As has already been mentioned, the above description of preferred embodiments does not intend to limit the invention to fuel containers, let alone to fields in which fuel cells are used. It is easily evident that the present invention can also be advantageously used for printers/photocopiers which have ink or toner supplied thereto via cartridges. Another advantageous field of use are gas cartridges/cylinders, which are used e.g. for operating gas stoves, boilers and other consumers used in the field of caravans/boats and also in normal households that are not connected to a municipal or regional gas distribution system. The method according to the present invention is definitely not restricted to exchangeable fluid containers, but it can also be used in the case of fixedly installed, refillable containers, e.g. for monitoring (and indicating, if necessary) the content of a fuel oil tank, the content of a container for liquids used in windshield washer systems, etc.. The scope of protection of the present invention is defined by the following claims alone.

1. A method of monitoring the amount of fluid in a fluid container, comprising the following steps:
determining, at a first moment in time, the amount of fluid contained in the fluid container, for which purpose information provided on the fluid container is read out;
determining, at a second moment in time, the amount of fluid that has been removed from the fluid container between said first and second moments in time, and storing at least one quantity which is representative of the amount of fluid contained in the fluid container at said second moment in time.

2. A method according to claim 1, wherein the determination of the amount of fluid contained in the fluid container at the first moment in time comprises the readout of an information storage means.

3. A method according to claim 1, comprising:
indicating the at least one quantity which is representative of the amount of fluid in the fluid container.

4. A method according to claim 1, wherein the at least one quantity comprises the residual amount of fluid in the fluid container and/or the residual operating time of a device operated with said fluid and/or the number of operations which can still be carried out with said residual amount of fluid.

5. A method according to claim 1, comprising:
executing safety measures, if said at least one representative quantity falls below or exceeds at least one predetermined value and/or if the information provided on the fluid container cannot be read out and/or if no information is provided on the fluid container and/or if it is not possible to read from and/or write to the information storage means.

6. A method according to claim 5, wherein said safety measures comprise sending an acoustic and/or optical signal and/or blocking the withdrawal of fluid.

7. A method according to claim 1, wherein the readout and/or storing of information causes irreversible changes in the information storage means.

8. A fluid container comprising:
an information storage means.

9. A fluid container according to claim 8, comprising:
an encoded means.

10. A fluid container according to claim, wherein the storage of information in the information storage means of the fluid container causes irreversible changes in said information storage means.

11. A fluid container according to claim 10, wherein the information storage means comprises an arrangement of conductor tracks, the information being stored in said arrangement of intact or defective conductor tracks.

12. A fluid container according to claim 8, wherein the information storage means comprises an electric and/or magnetic data memory.

13. A fluid container according to claim 12, wherein the information storage means comprises an EEPROM-chip and/or a magnetic foil.

14. A fluid withdrawal system for use in a fluid container according to claim 8, comprising:
a fluid withdrawal means that is adapted to have the fluid container connected thereto,
a control unit,
a read/write unit for reading information from the information storage means of the fluid container.

15. A fluid withdrawal system according to claim 14, wherein the read/write unit is additionally implemented such that the information storage means of the fluid container can be written to by said read/write unit.

16. A fluid withdrawal system according to claim 14, comprising:
an information storage means.

17. A method according to claim 5, wherein the readout and/or storing of information causes irreversible changes in the information storage means.

18. A fluid container according to claim 9, wherein the storage of information in the information storage means of the fluid container causes irreversible changes in said information storage means.

19. A fluid withdrawal system for use in a fluid container according to claim 9, comprising:
a fluid withdrawal means that is adapted to have the fluid container connected thereto,
a control unit,
a read/write unit for reading information from the information storage means of the fluid container.

20. A fluid withdrawal system according to claim 15, comprising:
an information storage means.
